(19) United States
(12) Patent Application Publication
(10) Pub. No.: US 2019/0128441 A1
(43) Pub. Date: May 2, 2019

(54) Pressure-Balanced Fluidic Actuation Mechanism for a Valve

(71) Applicant: Sun Hydraulics, LLC, Sarasota, FL (US)

(72) Inventor: Bernd Zähe, Sarasota, FL (US)

(21) Appl. No.: 15/797,194

(22) Filed: Oct. 30, 2017

(51) Int. Cl. F16K 31/122; F16K 3/26

(52) U.S. Cl. CPC F16K 31/1221; F16K 3/26

(57) ABSTRACT

An example fluidic actuation mechanism includes: (i) a piston having: a first flanged portion with a first annular surface area, a second flanged portion with a second annular surface area, where the first flanged portion and the second flanged portion project from an exterior peripheral surface of the piston, and a longitudinal cavity bounded by an interior peripheral surface of the piston; and (ii) a pin disposed in the longitudinal cavity of the piston. The pin engages the piston such that a force applied on the pin in a given axial direction is transferred to the piston. A difference between the second annular surface area of the second flanged portion and the first annular surface of the first flanged portion is substantially equal to a cross-sectional area of the pin.

### BACKGROUND

A valve actuator is the mechanism for opening and closing a valve. Manually operated valves require someone in attendance to adjust them using a mechanism attached to a movable element (e.g., a poppet or a spool) of the valve. Power-operated actuators, using gas pressure, hydraulic pressure, or electricity, allow a valve to be adjusted remotely.

Air (or other gas) pressure is the power source for pneumatic valve actuators. In an example valve, air pressure acts on a piston or bellows diaphragm creating linear force on the movable element of the valve. A pneumatic actuator may be arranged to be spring-closed or spring-opened, with air pressure overcoming the spring and inlet pressure to the valve to provide movement. A central compressed air system can provide the clean, dry, compressed air needed for pneumatic actuators.

Hydraulic valve actuators convert fluid (e.g., hydraulic oil) pressure into motion. For example, fluid pressure acting on a piston provides a force to move the movable element of the valve.

Thus, in examples, whether the valve is pneumatically or hydraulically operated, the air or oil pressure acts on a piston to move the movable element of the valve. In some cases, the inlet pressure of the valve, which could be as high as 6000 pounds per square inch (psi), for example, opposes the movement of the movable element. As a result, the piston is made to have a large diameter to increase the force applied on the piston by the actuation air or oil pressure.

Further, once the valve opens, e.g., the movable element of the valve exposes an outlet port to fluid at an inlet port, pressure at the inlet port may collapse suddenly as a result of fluid flow from the inlet port to the outlet port. Sudden collapse of inlet pressure that opposes the force applied by the actuation air or oil pressure acting on the piston may cause a sudden movement or jump in the position of the piston. As a result, it may be difficult to achieve proportional control of the position of the movable element of the valve based on a pressure level of the actuation air or oil pressure.

Therefore, it may be desirable to have a valve that has a pneumatic or hydraulic actuation mechanism that enables using reducing a diameter of an actuation piston, and achieve proportional control of the movable element of the valve based on the pressure level of the actuation pressure.

### SUMMARY

The present disclosure describes implementations that relate to a pressure-balanced fluidic actuation mechanism for a valve. In a first example implementation, the present disclosure describes a fluidic actuation mechanism for a valve. The fluidic actuation mechanism includes a piston having: (i) a first flanged portion with a first annular surface area, (ii) a second flanged portion with a second annular surface area, where the first flanged portion and the second flanged portion project from an exterior peripheral surface of the piston, and (iii) a longitudinal cavity bounded by an interior peripheral surface of the piston. The fluidic actuation mechanism also includes a pin disposed in the longitudinal cavity of the piston. The pin engages the piston such that a force applied on the pin in a given axial direction is transferred to the piston. A difference between the second annular surface area of the second flanged portion and the first annular surface of the first flanged portion is substantially equal to a cross-sectional area of the pin.

In a second example implementation, the present disclosure describes another fluidic actuation mechanism for a valve. The fluidic actuation mechanism includes a sleeve having a first longitudinal cavity therein, where the sleeve defines an actuation port configured to be fluidly coupled to a source of actuation pressurized fluid. The fluidic actuation mechanism also includes a piston disposed in the first longitudinal cavity coaxial with the sleeve, such that when the actuation pressurized fluid is received at the actuation port of the sleeve, the actuation pressurized fluid applies a force on the piston to cause the piston to move in a first axial direction. The piston has: (i) a first flanged portion having a first annular surface area, (ii) a second flanged portion having a second annular surface area, where the first flanged portion and the second flanged portion project from an exterior peripheral surface of the piston, and (iii) a second longitudinal cavity bounded by an interior peripheral surface of the piston. The fluidic actuation mechanism further includes a pin disposed and axially movable in the second longitudinal cavity of the piston. The pin is configured to be subjected to pressurized fluid from an inlet of the valve. The pin engages the piston such that a force applied on the pin via the pressurized fluid in a second axial direction opposite the first axial direction is transferred to the piston. A difference between the second annular surface area of the second flanged portion and the first annular surface of the first flanged portion is substantially equal to a cross-sectional area of the pin, such that when the pressurized fluid from the inlet of the valve is communicated to the first annular surface area and the second annular surface area, the piston is pressure-balanced.

In a third example implementation, the present disclosure describes a valve. The valve includes: a main valve section including: (i) a housing, (ii) a first sleeve disposed in the housing, where the first sleeve defines a first port and a second port, and (iii) a movable element configured to move axially in the first sleeve. The valve also includes a fluidic actuation mechanism. The fluidic actuation mechanism includes a second sleeve disposed in the housing and having a first longitudinal cavity therein, where the second sleeve defines an actuation port configured to be fluidly coupled to a source of actuation pressurized fluid. The fluidic actuation mechanism also includes a piston disposed and axially movable in the first longitudinal cavity of the second sleeve, where the piston has: (i) a first flanged portion having a first annular surface area, (ii) a second flanged portion having a second annular surface area, where the first flanged portion and the second flanged portion project from an exterior peripheral surface of the piston, and (iii) a second longitudinal cavity bounded by an interior peripheral surface of the piston. The fluidic actuation mechanism further includes a pin disposed and axially movable in the second longitudinal cavity of the piston. The pin is disposed adjacent the movable element of the main valve section. The pin engages the piston such that a force applied on the pin in a first axial direction via pressurized fluid received at the first port and acting on a cross-sectional area of the pin is transferred to the piston. A difference between the second annular surface area of the second flanged portion and the first annular surface area of the first flanged portion is substantially equal to the cross-sectional area of the pin, such that when pressurized fluid is communicated from the first port to the first annular surface area and the second annular surface area, the piston is pressure-balanced. When the actuation pressurized fluid is received at the actuation port of the second sleeve, the actuation pressurized fluid applies a force on the piston to cause the piston to move in a second axial direction opposite the first axial direction, causing the pin to move in the second axial direction, engage the movable element, and cause the movable element to move in the second axial direction.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying drawings, wherein:

FIG. 1 illustrates a cross-sectional view of an example valve, in accordance with an example implementation.

FIG. 2 illustrates a cross-sectional view of another example valve having a pressure-balanced fluidic actuation mechanism, in accordance with an example implementation.

FIG. 3 illustrates a flowchart of an example method of operating a valve, in accordance with an example implementation.

### DETAILED DESCRIPTION

Disclosed examples will now be described more fully hereinafter with reference to the accompanying drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

Within examples, a pressure-balanced fluidic (e.g., pneumatic or hydraulic) actuation mechanism for a valve is described herein. In an example, inlet pressure of fluid received at an inlet port of the valve is communicated to a piston, where the fluid applies forces on the piston that render the piston pressure-balanced. As such, the piston can be made to have a relatively small diameter compared to an implementation where the piston is not pressure-balanced. Further, the pressure-balanced configuration disclosed herein is insensitive to the pressure level at the inlet port. Thus, pressure level of the pneumatic or hydraulic pressure applied to the piston to actuate the valve is proportional to a position of a main or primary movable element (poppet or spool) of the valve.

Herein, the term “fluid” is used to include both gas (e.g., air) and liquid (e.g., hydraulic oil). Thus, in the present disclosure, the term “fluidic actuation mechanism” of a valve is used to refer to a pneumatic or hydraulic actuation mechanism of a valve.

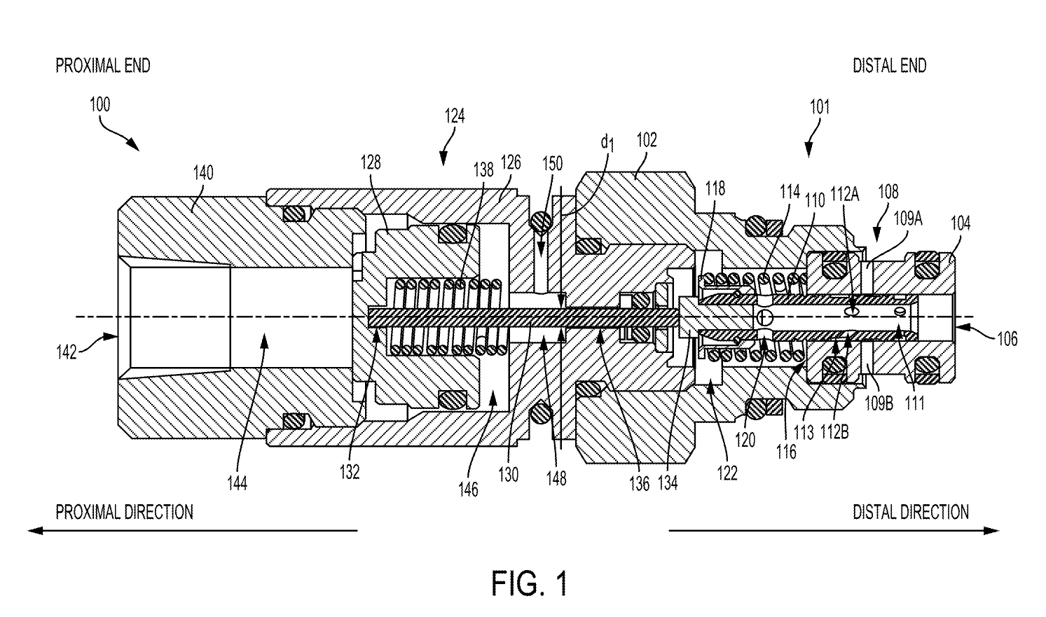

Referring now to the figures, FIG. 1 illustrates a cross-sectional view of an example valve 100, in accordance with an example implementation. The valve 100 may include a main valve section 101 that includes a housing 102, where the housing 102 defines a longitudinal cylindrical cavity therein. The longitudinal cylindrical cavity of the housing 102 is configured to receive a first cage or first sleeve 104 coaxial with the housing 102. The first sleeve 104 defines a first opening or port 106 and a second opening or port 108. The first port 106 is defined at an end or a nose of the first sleeve 104, whereas the second port 108 may be defined as holes such as holes 109A, 109B disposed in a radial array about an exterior peripheral surface of the first sleeve 104.

In examples, the first port 106 may be fluidly coupled to a source of pressurized fluid (e.g., a pump, an accumulator, or any other hydraulic component of a hydraulic system). The valve 100 is configured to control flow of fluid from the source of pressurized fluid to a tank or another hydraulic component (e.g., another valve) fluidly coupled to the second port 108.

In other examples, the second port 108 may be fluidly coupled to the source of pressurized fluid, and the valve 100 controls flow of fluid from the source of pressurized fluid to a tank or another hydraulic component fluidly coupled to the first port 106. This way, the valve 100 may be referred to as bi-directional as the valve 100 is configured to allow and control fluid flow from the first port 106 to the second port 108 and from the second port 108 to the first port 106.

The first sleeve 104 defines a respective longitudinal cylindrical cavity therein. A poppet 110 is disposed partially in the cavity defined within the first sleeve 104 and partially in the cavity of the housing 102, and the poppet 110 is coaxial with the housing 102 and the first sleeve 104. Further, the poppet 110 is axially or longitudinally movable relative to the first sleeve 104 and the housing 102, which are fixed.

The poppet 110 is hollow and defines a longitudinal chamber 111 therein. The poppet 110 further includes cross holes that are disposed apart from each other in an axial direction along a length of the poppet 110. At a particular axial location on the poppet 110, the cross holes are disposed in a radial array about the poppet 110. For example, the poppet 110 includes cross holes 112A and 112B disposed radially about the exterior surface of the poppet 110. The cross holes 112A and 112B may be slanted or disposed at an angle relative to a longitudinal axis of the poppet 110. The cross holes 112A and 112B are configured to communicate fluid to and from an annular groove 113 disposed on an exterior peripheral surface of the poppet 110. In FIG. 1, the valve 100 is shown in a closed position where the annular groove 113 does not overlap axially with the cross holes 109A, 109B of the first sleeve 104.

The valve 100 further includes a spring 114 disposed around an exterior peripheral surface of the poppet 110 between an end 116 of the first sleeve 104, which is fixed, and a spring cap 118 coupled to an exterior surface of the poppet 110. With this configuration, the spring 114 applies a force on the spring cap 118, and thus on the poppet 110, in a proximal direction (e.g., to the left in FIG. 1).

Further, the poppet 110 includes a radial channel or cross hole(s) 120 that communicate fluid received at the first port 106 to a chamber 122 defined within the housing 102. In this manner, if the first port 106 is fluidly coupled to the source of pressurized fluid, the pressurized fluid at the first port 106 is communicated to the chamber 122 through the longitudinal chamber 111 and the cross hole(s) 120.

The poppet 110 is configured to move axially in the longitudinal cylindrical cavity defined within the first sleeve 104 when the valve 100 is actuated by a fluidic actuation mechanism 124. The fluidic actuation mechanism 124 includes a second sleeve 126 disposed partially within, and received at, a proximal end of the housing 102, such that the second sleeve 126 is coaxial with the housing 102. Further, the second sleeve 126 defines a respective longitudinal cylindrical cavity therein and houses a piston 128 that is axially movable within the longitudinal cylindrical cavity of the second sleeve 126.

The piston 128 also defines therein a respective longitudinal cylindrical cavity that houses a pin 130. A proximal end of the pin 130 is disposed within a recess or blind hole 132 formed in an interior proximal surface of the piston 128. The pin 130 extends longitudinally between the blind hole 132 and a plug 134 disposed at a proximal end of the poppet 110. The second sleeve 126 includes a protrusion 136 emanating from the interior peripheral surface of the second sleeve 126 to define a restriction therein through which the pin 130 is disposed.

The fluidic actuation mechanism 124 further includes a spring 138 disposed about an exterior peripheral surface of the pin 130 within the cavity defined by the piston 128. The spring 138 is supported between (i) the interior proximal surface of the piston 128, and (ii) an interior surface of the second sleeve 126.

The second sleeve 126 is fixed, whereas the piston 128 is axially movable in the longitudinal cylindrical cavity of the sleeve 126. Thus, the spring 138 applies a force on the piston 128 that maintains the piston 128 biased in the proximal direction, e.g., to the left in FIG. 1.

The fluidic actuation mechanism 124 further includes a cylindrical plug member 140 disposed partially within, and received at, a proximal end of the second sleeve 126. The cylindrical plug member 140 is hollow and defines an actuation port 142 formed as an opening at a proximal end of the cylindrical plug member 140.

The actuation port 142 is configured to be fluidly coupled to a source of actuation pressurized fluid to actuate the valve 100. For instance, the actuation port 142 may be fluidly coupled to a pump or an accumulator configured to provide actuation pressurized air or pressurized hydraulic oil (e.g., having pressure level in a range between 50 psi and 150 psi) to the actuation port 142.

In operation, the actuation pressurized fluid flows through an inner chamber 144 of the cylindrical plug member 140 and applies a pressure on a proximal end of the piston 128 in a distal direction (e.g., to the right in FIG. 1). A distal end of the piston 128 facing a gap 146 between the distal end of the piston 128 and the interior surface of the second sleeve 126 is exposed to atmospheric or environmental pressure through a chamber 148 and a channel 150 formed in the second sleeve 126. Thus, under pressure from the actuation pressurized fluid received at the actuation port 142, the piston 128 moves axially in the distal direction traversing at least a portion of the gap 146.

As the piston 128 moves axially in the distal direction, the piston 128 pushes the pin 130 in the distal direction as well due to the interaction between the piston 128 and the pin 130 at the blind hole 132. The piston 128 moves against a force of the spring 138, which tends to push the piston 128 in the proximal direction.

The pin 130 interfaces and interacts with the plug 134 disposed at the proximal end of the poppet 110. Thus, as the pin 130 moves in the distal direction, the pin 130 pushes the plug 134 in the distal direction, and the plug 134 in turn pushes the poppet 110 in the distal direction.

Movement of the poppet 110 in the distal direction causes the valve 100 to open as described below. To cause the poppet 110 to move axially in the distal direction, the actuation pressurized fluid received at the actuation port 142 acts on the piston 128 to overcome a force of the spring 138 and a force of the pressurized fluid received at the first port 106 acting on the pin 130. In particular, the pressurized fluid received at the first port 106 is communicated as described above through the longitudinal chamber 111 and the cross hole(s) 120 to the chamber 122. The pressurized fluid in the chamber 122 applies a force on the pin 130 in the proximal direction (e.g., to the left in FIG. 1).

This force acting on the pin 130 in the proximal direction may be determined as the pressure level of the pressurized fluid in the chamber 122 multiplied by cross-sectional area “A₁” of the pin 130 that is equal to

$$\frac{π {d}_{1}^{2}}{4}$$

where “d₁” is the diameter of the pin 130 as labelled in FIG. 1. Thus, assuming that the pressure level of the pressurized fluid “P,” then the force applied to the pin 130 is =PA₁. This force applied to the pin 130 is transferred to the piston 128 at the blind hole 132. Thus, the pressurized fluid received at the first port 106 and acting on the pin 130 applies a force on the piston 128 in the proximal direction against the force of the actuation pressurized fluid acting on the piston 128 in the distal direction.

As an example for illustration, the pressurized fluid at the first port 106 could have a pressure level of 5000 psi. Assuming that the pin 132 has a diameter d₁=0.08 inches, the force applied on the pin 130 (and thus on the piston 128) can be calculated to be 25.12 lbs. Assuming that the spring 138 applies a respective force on the piston 128 in the proximal direction of about 5 lbs, then the actuation pressurized fluid received at the actuation port 142 would overcome more than 30 lbs of force applied on the piston 128 in addition to seal friction forces and force of the spring 114 to move the poppet 110 in the distal direction.

Assuming that the pressure level of the actuation pressurized fluid received at the actuation port 142 is 100 psi, and assuming that the total force that the is overcome to move the poppet 110 is about 35 lbs, then a diameter of the piston 128 can be determined to be about 0.67 inches. This diameter could be considered large and could render the piston 128 heavy. The ratio of the diameter of the piston 128 relative to a diameter of the pin 130 causes the pressure level of the actuation pressurized fluid to be intensified at the proximal end of the pin 130. In other words, the pressure that the piston 128 applies to the pin 130 at the blind hole 132 is intensified relative to the pressure level of the actuation pressurized fluid received at the actuation port 142 to enable the pin 130 to overcome the force PA₁ applied to the pin 130 in the proximal direction via the pressurized fluid received at the first port 106 and communicated to the chamber 122.

The poppet 110 may move sufficiently, e.g., a predetermined distance, in the distal axial direction such that the annular groove 113 disposed on the exterior peripheral surface of the poppet 110 overlaps, at least partially, with the cross holes 109A, 1096B of the first sleeve 104. As a result, fluid received at the first port 106 is allowed to flow through the first port 106, the longitudinal chamber 111, the cross holes 112A, 112B, the annular groove 113, and the cross holes 109A, 109B to the second port 108. The fluid flow from the first port 106 to the second port 108 can be referred to as main flow, and the valve 100 is now in an open state.

Once the pressurized fluid received at the first port 106 starts to flow from the first port 106 to the second port 108, the pressure level of the pressurized fluid at the first port 106 collapses (i.e., is reduced at a high rate of reduction in pressure). Thus, the force that the actuation pressurized fluid received at the actuation port 142 has been applying to overcome an initial inlet pressure level at the first port 106 may cause the poppet 110 to move unexpectedly by a significant axial distance in the distal direction, causing large unexpected changes in the flow rate across the valve 100. This configuration may render the valve 100 operating as an on-off valve, as opposed to a proportional valve as may be desired. Also, such sudden changes in flow rate may cause an actuator (e.g., a cylinder or motor) or any other component controlled by the valve 100 to move faster than expected, which may be undesirable.

Further, the pressure level of the actuation pressurized fluid received at the actuation port 142 that causes the valve 100 to open is dependent on or sensitive to the pressure level of the pressurized fluid received at the first port 106. If the pressurized fluid at the first port 106 has a high pressure level such as 5000 psi, then a correspondingly high pressure level at the actuation port 142 causes the poppet 110 to move and cause the valve 100 to open. Conversely, if the pressurized fluid at the first port 106 has a lower pressure level such as 1000 psi, then a correspondingly low pressure level at the actuation port 142 causes the poppet 110 to move and cause the valve 100 to open. Thus, the “cracking” pressure level (i.e., the pressure level at the actuation port 142) that causes the poppet 110 to move sufficiently for fluid to start flowing from the first port 106 to the second port 108 varies based on the pressure level at the first port 106. Such variation in the “cracking” pressure level could also be undesirable in many applications.

Thus, it may be desirable to configure the valve 100 such that its fluidic actuation mechanism is pressure-balanced regardless of the pressure level at the first port 106. This way, the fluidic actuation mechanism is rendered insensitive to the pressure level at the first port 106, and thus the valve 100 can be operated proportionally with a consistent cracking pressure level.

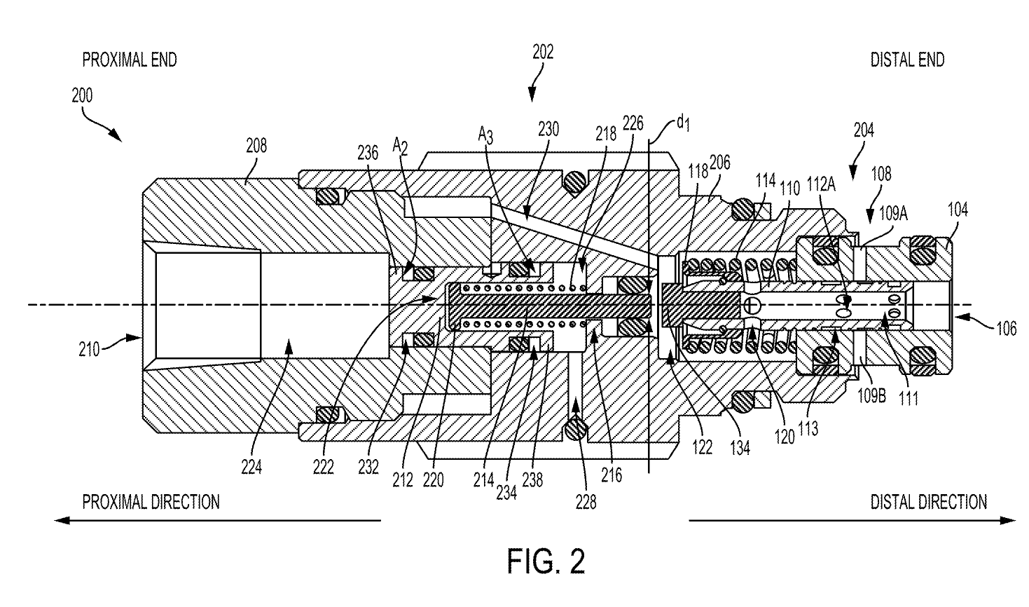

FIG. 2 illustrates a cross-sectional view of another example valve 200 having a fluidic actuation mechanism 202 that is pressure-balanced, in accordance with an example implementation. Similar components used in both the valve 100 and the valve 200 are designated with the same reference numbers. As shown, the valve 200 includes a main valve section 204 that has common components with the main valve section 101 described above. The valve 200 includes a housing 206 that houses portions of the main valve section 204 and portions of the fluidic actuation mechanism 202.

The fluidic actuation mechanism 202 includes a sleeve 208 that is similar to the cylindrical plug member 140 described above. The sleeve 208 is fixedly disposed partially in, and received at, a proximal end of the housing 206, and the sleeve 208 is coaxial with the housing 206. Similar to the cylindrical plug member 140, the sleeve 208 is hollow and defines an actuation port 210 formed as an opening at a proximal end of the sleeve 208.

The actuation port 210 is configured to be fluidly coupled to a source of actuation pressurized fluid (e.g., air of hydraulic fluid) to actuate the valve 200. For instance, the actuation port 210 may be fluidly coupled to a pump or an accumulator configured to provide actuation pressurized air or pressurized hydraulic oil (e.g., in a range between 50 psi and 150 psi) to the actuation port 210.

Further, the sleeve 208 defines a respective longitudinal cylindrical cavity therein to partially house a piston 212 that is axially movable within the longitudinal cylindrical cavity of the sleeve 208. The piston 212 also defines therein a respective longitudinal cylindrical cavity that houses a pin 214. The pin 214 extends longitudinally between the piston 212 and the plug 134 of the poppet 110. The housing 206 includes a protrusion 216 emanating from the interior peripheral surface of the housing 206 to define a restriction therein through which the pin 214 is disposed. In the position shown in FIG. 2, the pin 214 reaches the chamber 122 of the main valve section 204 such that a distal end of the pin 214 is adjacent a proximal end of the plug 134. However, the pin 214 might not be in contact with the plug 134 when the valve 200 is in the unactuated or closed position shown in FIG. 2.

The fluidic actuation mechanism 202 further includes a spring 218 disposed about an exterior peripheral surface of the pin 214 within the cavity defined by the piston 212. The spring 218 is supported between (i) the protrusion 216 defined by the interior peripheral surface of the housing 206, and (ii) a flanged portion 220 formed at the proximal end of the pin 214. The flanged portion 220 represents an area or portion of the pin 214 that has an enlarged diameter.

The housing 206 is fixed, whereas the pin 214 is axially movable relative to the housing 206. Thus, the spring 218 applies a force on the pin 214 that maintains the pin 214 biased in the proximal direction, e.g., to the left in FIG. 2.

Further, the piston 212 defines a blind end 222 in the longitudinal cylindrical cavity defined within the piston 212 such that the pin 214 can rest against the interior surface of the piston 212 at the blind end 222. With this configuration, the pin 214 engages the piston 212 at the blind end 222. Specifically, the flanged portion 220 of the pin 214 can rest against the interior surface of the piston 212 at the blind end 222, such that forces applied to the pin 214 in the proximal direction (e.g., to the left in FIG. 2) are transferred to the piston 212 via the interaction between the pin 214 and the piston 212 at the blind end 222. Also, if the piston 212 moves in the distal direction (e.g., to the right in FIG. 2) under pressure from the actuation pressurized fluid received at the actuation port 210, the piston 212 engages with and applies a force on the pin 214 causing the pin 214 to move with the piston 212 in the distal direction against a force of the spring 218.

In operation, the actuation pressurized fluid flows through an inner chamber 224 of the sleeve 208 and applies a force on a proximal end of the piston 212 in the distal direction (e.g., to the right in FIG. 2). A distal end of the piston 212 facing a gap 226 between the distal end of the piston 212 and an interior surface of the protrusion 216 of the housing 206 is exposed to atmospheric or environmental pressure through a channel 228 formed in the housing 206. Thus, under pressure from the actuation pressurized fluid received at the actuation port 210, the piston 212 moves axially in the distal direction to traverse at least a portion of the gap 226.

As the piston 212 moves axially in the distal direction, the piston 212 pushes the pin 214 in the distal direction as well due to the interaction between the piston 212 and the pin 214, and specifically the interaction between the blind end 222 and the flanged portion 220. The piston 212 moves against a force of the spring 218 and against a force of the pressurized fluid received at the first port 106 acting on the pin 214. In particular, the pressurized fluid received at the first port 106 is communicated as described above through the longitudinal chamber 111 and the cross hole(s) 120 to the chamber 122. The pressurized fluid in the chamber 122 applies a force on the distal end of the pin 214 in the proximal direction (e.g., to the left in FIG. 2).

The force acting on the pin 214 in the proximal direction may be determined as the pressure level of the pressurized fluid in the chamber 122 multiplied by cross-sectional area “A₁” of the pin 214 that is equal to

$$\frac{π {d}_{1}^{2}}{4}$$

where “d₁” is the diameter of the pin 214 as labelled in FIG. 2. Thus, assuming that the pressure level of the pressurized fluid “P,” then the force applied to the pin 214 is =PA₁. This force acts in the proximal direction, e.g., to the left in FIG. 2, and the force is transferred to the piston 212 via the flanged portion 220.

The pressurized fluid in the chamber 122 is further communicated through a slanted channel 230 formed in the housing 206 and through an unsealed space at the interface between a distal end of the sleeve 208 and an interior surface of the housing 206 to the exterior peripheral surface of the piston 212. The pressurized fluid is then communicated through unsealed space between the exterior peripheral surface of the piston 212 and the interior peripheral surface of the sleeve 208 to a first circumferential annular groove 232 defined in the exterior peripheral surface of the piston 212. The pressurized fluid is also communicated through the unsealed space between the exterior peripheral surface of the piston 212 and the interior peripheral surface of the housing 206 to a second circumferential annular groove 234 defined in the exterior peripheral surface of the piston 212.

The first circumferential annular groove 232 is bounded by a flanged portion 236 defined at a proximal end of the piston 212, and the second circumferential annular groove 234 is bounded by a flanged portion 238 defined at a distal end of the piston 212. The pressurized fluid thus applies a force on an annular surface area “A₂” of the flanged portion 236 in a first (proximal) axial direction, and applies a force on an annular surface area “A₃” of the flanged portion 238 in a second (distal) axial direction opposite the first (proximal) axial direction. Therefore, the resultant force acting on the piston 212 can be estimated by the following equation:

F=PA₁+PA₂−PA₃=P(A₁+A₂−A₃) (1)

The valve 200 is configured such that the area difference A₃−A₂ is substantially equal to the area A₁. As a result, (A₁+A₂−A₃) is substantially equal to zero, and thus the force “F” defined by equation (1) is substantially equal to zero (e.g., within a threshold force value, such as 3 lbs, from zero lbs). The term “substantially” is used, for example, to indicate that the area difference A₃−A₂ is equal to the area A₁ or within a threshold area or percentage area (e.g., ±1-5%) from the area A₁. In addition, by the term “substantially” used above and throughout the description herein, it is meant that the recited characteristic, parameter, measurement, or value need not be achieved exactly, but that deviations or variations, including for example, tolerances, measurement error, measurement accuracy limitations, manufacturing deviations, and other factors known to those skilled in the art, may occur in amounts that do not preclude the effect the characteristic was intended to provide.

With this configuration, the piston 212 is pressure-balanced because the pressurized fluid communicated from the first port 106 exerts opposing forces on the piston 212 on surface areas that are selected such that the resultant force exerted on the piston 212 is substantially equal to zero. As a result, the diameter of the piston 212 can be configured to be smaller than the diameter of the piston 128 described above.

Using the example illustration described above with respect to FIG. 1, the diameter “d₁” of the pin 214 is 0.08 inches, and the pressure level “P” is about 5000 psi, then the force applied on the pin 214 in the first (proximal) axial direction can be determined to be about 25 lbs that is transferred to the piston 212. In contrast to the piston 128, the piston 212 is pressure-balanced, and thus the pressurized fluid communicated to the first and second circumferential annular grooves 232 and 234 substantially cancel the 25 lbs force transferred from the pin 214 to the piston 212.

Thus, regardless of the pressure level of the pressurized fluid received at the first port 106, the actuation pressurized fluid received at the actuation port 210 overcomes a force of the spring 218 to actuate the valve 200, but not the force applied by the pressurized fluid received at the first port 106 on the pin 214. As a result, the piston 212 can have a smaller diameter. For instance, assuming that the pressure level of the actuation pressurized fluid received at the actuation port 210 is 100 psi, and assuming that the force of the spring 218 is about 5 lbs, then then a diameter of the piston 212 can be determined to be about 0.25 inches (smaller than the 0.67 calculated above for the piston 128). Thus, actuation pressurized fluid having a pressure level of 100 psi acting on the piston 212 having 0.25 inch diameter can overcome the force of the spring 218 and move the piston 212 and the pin 214 in the distal direction.

As the pin 214 moves in the distal direction, it engages with (e.g., contacts) and pushes the plug 134 disposed at the proximal end of the poppet 110. The plug 134 in turn pushes the poppet 110 in the distal direction until the annular groove 113 disposed on the exterior peripheral surface of the poppet 110 overlaps with the cross holes 109A, 109B of the first sleeve 104. As a result, fluid received at the first port 106 is allowed to flow through the first port 106, the longitudinal chamber 111, the cross holes 112A, 112B, the annular groove 113, and the cross holes 109A, 109B to the second port 108.

With the pressure-balanced configuration of the piston 212, operation of the fluidic actuation mechanism 202 is insensitive to variation of the pressure level “P” at the first port 106. As mentioned above, once fluid is allowed to flow from the first port 106 to the second port 108, the pressure level “P” at the first port 106 may be reduced (e.g., collapses). However, regardless of the pressure level “P,” the pressurized fluid is communicated from the first port 106 to the fluidic actuation mechanism 202 and applies forces on the areas A₁, A₂, and A₃ as described above, and the piston 212 is maintained in a pressure-balanced state. Thus, regardless of the variation of the pressure level “P,” the actuation pressurized fluid overcomes a spring force of the spring 218, friction forces, and the force of the spring 114 to actuate the valve 200.

This way, consistent operation of the fluidic actuation mechanism 202 is achieved. In other words, for a particular pressure level of the actuation pressurized fluid received at the actuation port 210, the poppet 110 moves in the distal direction a corresponding axial distance that is substantially consistent regardless of the pressure level “P” at the first port 106. As the pressure level of the actuation pressurized fluid at the actuation port 210 changes, the axial distance that the poppet 110 moves changes substantially proportionally to the change in the pressure level of the actuation pressurized fluid. Thus, proportional control of the valve 200 via fluidic actuation can be achieved.

Further, with the configuration of the valve 200, the pressure level of the actuation pressurized fluid received at the actuation port 210 that causes the valve 200 to open is no longer dependent on or sensitive to the pressure level of the pressurized fluid received at the first port 106. Whether the pressurized fluid at the first port 106 has a high pressure level such as 5000 psi or a low pressure such as 1000 psi, substantially the same pressure level at the actuation port 210 causes the poppet 110 to move and cause the valve 200 to open. Thus, the “cracking” pressure level that causes the poppet 110 to move sufficiently for fluid to start flowing from the first port 106 to the second port 108 does not vary based on the pressure level at the first port 106.

Thus, with the pressure-balanced configuration of the fluidic actuation mechanism 202, the valve 200 is rendered insensitive to the pressure level at the first port 106, and thus the valve 200 can be operated proportionally with a consistent cracking pressure level.

The configurations and components shown in FIG. 2 are examples for illustration, and different configurations and components could be used. For example, different types of springs could be used. In other examples, several components may be integrated into a single component rather than having separate components to simplify the valve 200.

Further, the valve 200 is shown as a poppet valve (e.g., having the poppet 110); however, the fluidic actuation mechanism 202 having a pressure-balanced piston (e.g., the piston 212) could also be implemented for other valve configurations. For instance, the fluidic actuation mechanism 202 described herein could be coupled to a spool of a spool valve to enhance fluidic actuation of the spool, reduce complexity of the spool valve, and achieve consistent operation regardless of an inlet pressure level. As such, the description above with respect to the fluidic actuation mechanisms can be applied to any valve with axially or longitudinally movable element(s), whether the movable element(s) are poppets or spools.

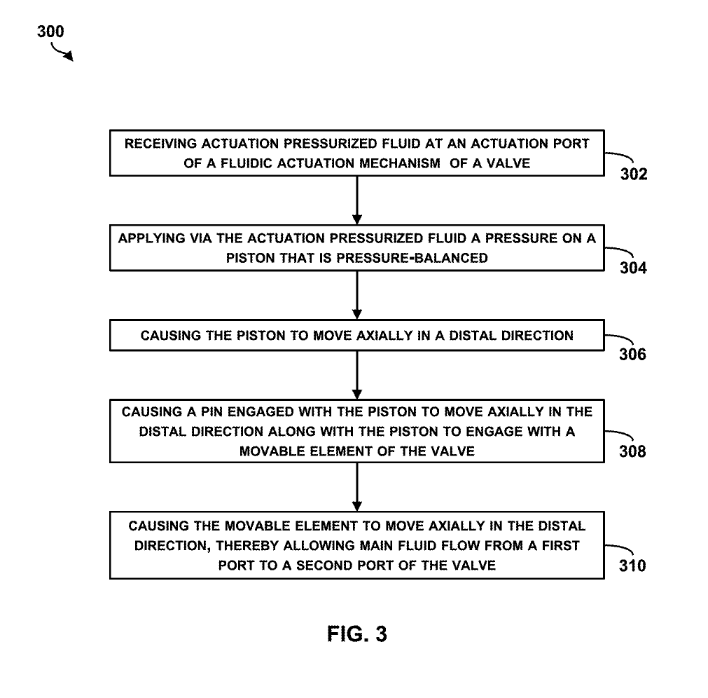

FIG. 3 illustrates a flowchart of a method 300 for operating a valve, in accordance with an example implementation. The method 300 shown in FIG. 3 presents an example of a method that could be used with the valve 200 shown in FIG. 2, for example. The method 300 may include one or more operations, functions, or actions as illustrated by one or more of blocks 302-310. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 302, the method 300 includes receiving actuation pressurized fluid at the actuation port 210 of the fluidic actuation mechanism 202 of the valve 200.

At block 304, the method 300 includes applying via the actuation pressurized fluid a pressure on the piston 212 that is pressure-balanced. For instance, the actuation pressurized fluid applies the pressure on a proximal end face of the piston 212 in the distal direction.

At block 306, the method 300 includes causing the piston 212 to move axially in a distal direction. The piston 212 moves in the distal direction against a force of the spring 218 and seal friction forces.

At block 308, the method 300 includes causing the pin 214 engaged with the piston 212 to move axially in the distal direction along with the piston 212 to engage with a movable element, e.g., the poppet 110, of the valve 200. As described above, the pin 214 is disposed partially within the piston 212, and as the piston 212 moves axially, the interior surface of the piston 212 at its blind end 222 interacts with the flanged portion 220 of the pin 214 and causes the pin 214 to move axially as well. The pin 214 traverses a particular gap in the chamber 122 and contacts the plug 134 disposed at the proximal end of the poppet 110.

At block 310, the method 300 includes causing the movable element, e.g., the poppet 110, to move axially in the distal direction, thereby allowing main fluid flow from the first port 106 to the second port 108. As the piston 212 and the pin 214 continue to move in the distal direction, the pin 214 engages the plug 134 and the poppet 110 and causes them to move axially in the distal direction. Once the pin 214 engages the plug 134 and the poppet 110, the piston 212 and the pin 214 move in the distal direction against the force of the spring 218, seal friction forces, and a force of the spring 114.

When the poppet 110 has moved axially a sufficient distance such that the annular groove 113 axially overlaps, at least partially, the cross holes 109A, 109B, a fluid path is formed from the first port 106 through the longitudinal chamber 111, the cross holes 112A, 112B, the annular groove 113, and the cross holes 109A, 109B to the second port 108. The valve 200 is now open and main flow is generated through the valve 200.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

What is claimed is:

1. A fluidic actuation mechanism for a valve, the fluidic actuation mechanism comprising:
a piston having: (i) a first flanged portion with a first annular surface area, (ii) a second flanged portion with a second annular surface area, wherein the first flanged portion and the second flanged portion project from an exterior peripheral surface of the piston, and (iii) a longitudinal cavity bounded by an interior peripheral surface of the piston; and
a pin disposed in the longitudinal cavity of the piston, wherein the pin engages the piston such that a force applied on the pin in a given axial direction is transferred to the piston, and wherein a difference between the second annular surface area of the second flanged portion and the first annular surface of the first flanged portion is substantially equal to a cross-sectional area of the pin.

2. The fluidic actuation mechanism of claim 1, wherein the longitudinal cavity is a first longitudinal cavity, and wherein the fluidic actuation mechanism further comprises:
a sleeve having a second longitudinal cavity therein, wherein the piston is disposed, and is axially movable, in the second longitudinal cavity of the sleeve.

3. The fluidic actuation mechanism of claim 2, wherein the given axial direction is a first axial direction, wherein the sleeve defines an actuation port configured to be fluidly coupled to a source of actuation pressurized fluid, such that when the actuation pressurized fluid is received at the actuation port of the sleeve, the actuation pressurized fluid applies a force on the piston to cause the piston to move in a second axial direction opposite the first axial direction.

4. The fluidic actuation mechanism of claim 3, wherein the valve includes a housing having a third longitudinal cavity, wherein the sleeve is partially received within the third longitudinal cavity of the housing.

5. The fluidic actuation mechanism of claim 4, wherein the valve further comprises a movable element disposed within the third longitudinal cavity of the housing, and wherein an end of the pin is disposed adjacent the movable element, such that when the piston moves in the second axial direction, the pin moves in the second axial direction, thereby engaging the movable element and causing the movable element to move in the second axial direction within the housing.

6. The fluidic actuation mechanism of claim 1, further comprising:
a spring disposed between an exterior peripheral surface of the pin and the interior peripheral surface of the piston such that the spring applies a spring force on the pin and the piston in the given axial direction.

7. The fluidic actuation mechanism of claim 6, wherein the spring is disposed between the flanged portion of the pin and an interior surface of a housing of the valve.

8. A fluidic actuation mechanism for a valve, the fluidic actuation mechanism comprising:
a sleeve having a first longitudinal cavity therein, wherein the sleeve defines an actuation port configured to be fluidly coupled to a source of actuation pressurized fluid;
a piston disposed in the first longitudinal cavity coaxial with the sleeve, such that when the actuation pressurized fluid is received at the actuation port of the sleeve, the actuation pressurized fluid applies a force on the piston to cause the piston to move in a first axial direction, wherein the piston has: (i) a first flanged portion having a first annular surface area, (ii) a second flanged portion having a second annular surface area, wherein the first flanged portion and the second flanged portion project from an exterior peripheral surface of the piston, and (iii) a second longitudinal cavity bounded by an interior peripheral surface of the piston; and
a pin disposed and axially movable in the second longitudinal cavity of the piston, wherein the pin is configured to be subjected to pressurized fluid from an inlet of the valve, wherein the pin engages the piston such that a force applied on the pin via the pressurized fluid in a second axial direction opposite the first axial direction is transferred to the piston, and wherein a difference between the second annular surface area of the second flanged portion and the first annular surface of the first flanged portion is substantially equal to a cross-sectional area of the pin, such that when the pressurized fluid from the inlet of the valve is communicated to the first annular surface area and the second annular surface area, the piston is pressure-balanced.

9. The fluidic actuation mechanism of claim 8, wherein the valve includes a housing having a third longitudinal cavity, wherein the sleeve is partially received within the third longitudinal cavity of the housing.

10. The fluidic actuation mechanism of claim 9, wherein the valve further comprises a movable element disposed within the third longitudinal cavity of the housing, and wherein an end of the pin is disposed adjacent the movable element, such that when the piston moves in the first axial direction, the pin moves in the first axial direction, thereby engaging the movable element and causing the movable element to move in the first axial direction within the housing.

11. The fluidic actuation mechanism of claim 8, further comprising:
a spring disposed between an exterior peripheral surface of the pin and the interior peripheral surface of the piston such that the spring applies a spring force on the pin and the piston in the second axial direction.

12. The fluidic actuation mechanism of claim 11, wherein the spring is disposed between the flanged portion of the pin and an interior surface of a housing of the valve.

13. A valve comprising:
a main valve section comprising: (i) a housing, (ii) a first sleeve disposed in the housing, wherein the first sleeve defines a first port and a second port, and (iii) a movable element configured to move axially in the first sleeve; and
a fluidic actuation mechanism comprising:
a second sleeve disposed in the housing and having a first longitudinal cavity therein, wherein the second sleeve defines an actuation port configured to be fluidly coupled to a source of actuation pressurized fluid,
a piston disposed and axially movable in the first longitudinal cavity of the second sleeve, wherein the piston has: (i) a first flanged portion having a first annular surface area, (ii) a second flanged portion having a second annular surface area, wherein the first flanged portion and the second flanged portion project from an exterior peripheral surface of the piston, and (iii) a second longitudinal cavity bounded by an interior peripheral surface of the piston, and
a pin disposed and axially movable in the second longitudinal cavity of the piston, wherein the pin is disposed adjacent the movable element of the main valve section, wherein the pin engages the piston such that a force applied on the pin in a first axial direction via pressurized fluid received at the first port and acting on a cross-sectional area of the pin is transferred to the piston, and wherein a difference between the second annular surface area of the second flanged portion and the first annular surface area of the first flanged portion is substantially equal to the cross-sectional area of the pin, such that when pressurized fluid is communicated from the first port to the first annular surface area and the second annular surface area, the piston is pressure-balanced, and wherein
when the actuation pressurized fluid is received at the actuation port of the second sleeve, the actuation pressurized fluid applies a force on the piston to cause the piston to move in a second axial direction opposite the first axial direction, causing the pin to move in the second axial direction, engage the movable element, and cause the movable element to move in the second axial direction.

14. The valve of claim 13, wherein the fluidic actuation mechanism further comprises:
a spring disposed between an exterior peripheral surface of the pin and the interior peripheral surface of the piston such that the spring applies a spring force on the pin and the piston in the first axial direction.

15. The valve of claim 14, wherein the spring is disposed between the flanged portion of the pin and an interior surface of the housing of the valve.

16. The valve of claim 15, wherein movable element is hollow and defines a longitudinal chamber therein, wherein the longitudinal chamber is configured to communicate fluid from the first port to the pin to cause the force acting on the cross-sectional area of the pin.

17. The valve of claim 16, wherein the movable element comprises:
an annular groove disposed on an exterior peripheral surface of the movable element; and
a plurality of cross holes disposed in a radial array about the movable element and configured to fluidly couple the longitudinal chamber to the annular groove.

18. The valve of claim 17, wherein the first sleeve includes a respective plurality of cross holes that fluidly couple a cavity within the first sleeve where the movable element is disposed to the second port of the first sleeve.

19. The valve of claim 18, wherein when the movable element moves a predetermined distance in the second axial direction, the annular groove of the movable element overlaps, at least partially, the respectively plurality of cross holes of the first sleeve such that the pressurized fluid is allowed to flow from the first port through the longitudinal chamber of the movable element, the plurality of cross holes of the movable element, the annular groove, and the respective plurality of holes of the first sleeve to the second port.

20. The valve of claim 13, wherein housing of the main valve section comprises a protrusion emanating from an interior peripheral surface of the housing to define a restriction therein through which the pin of the fluidic actuation mechanism is disposed.
